(19) United States
(12) Patent Application Publication
(10) Pub. No.: US 2015/0233166 A1
(43) Pub. Date: Aug. 20, 2015

(54) GATE WITH FAN OUT OPENING SYSTEM

(71) Applicant: Nello TRINCIARELLI, Volterra (PI) (IT)

(72) Inventor: Nello Trinciarelli, Volterra (IT)

(21) Appl. No.: 14/427,477

(22) PCT Filed: Sep. 13, 2013
(86) PCT No.: PCT/IB2013/058543

§ 371 Date: Mar. 11, 2015

(30) Foreign Application Priority Data
Sep. 14, 2012 (IT) PI2012A000097

(51) Int. Cl. E05F 15/51; E06B 9/06; E06B 3/92; E05F 15/53; E06B 3/38

(52) U.S. Cl. CPC E05F 15/51; E05F 15/53; E06B 3/38; E06B 3/92; E06B 9/06; E05F 2017/008

(57) ABSTRACT

In the opening phase the problem which often arises with gates and window frames is the space they occupy, whether they have hinged doors, whether it be of sliding doors in horizontal or vertical direction. The invention applied to gates and windows consists of a system of opening as a hand fan that makes disappear the doors in a minimum of space such that they can be integrated in the column of a gate or in the section of a wall.

### TECHNICAL FIELD

The invention relates to doors of gates and windows and in particular a construction system designed to optimize their mode of opening and closing.

### BACKGROUND ART

Conventional gates and windows have hinged openings, horizontally or vertically scrolling or folding.

A first problem that afflicts the aforesaid traditional devices is the space occupied by the door of the gate or window in the opening phase. With gates they often do not have sufficient space for the door that when it opens occupies a room outside the passage opening so blocking another pass, intercepting an obstacle or trespassing in another property. In the case of the windows or internal doors the problem is often solved with the door which slides inside a compartment formed in the wall which encompass the passage, however, it can happen to be unable to obtain in the wall a room sufficient to allow the opening of the window or door.

A second problem that occurs with gates is the slope of the access road. With a sloping road alternatives for traditional gates are: hinged doors opening to the valley, doors with sloped axis of its hinges (the gate tilts while it opens), doors with a movable lower area so as to follow the inclination of the land, doors sliding laterally or vertically. In each case we have constructive complications which greatly increase the production costs of said devices.

A third problem is the end of stroke for swing gates: this device is often an obstacle to the passage mainly with sloping access.

A fourth problem is the application of a motor drive to a traditional gate when this is applied after the installation of the gate itself. This means longer installation time and incompatibility between the procedure of installation of the gate and the installation of the motor.

### SUMMARY OF THE INVENTION

Object of the present invention is therefore to propose gates or doors/windows characterized by a particular construction system able to overcome the limitations described above of conventional gates and doors/windows.

The above objects are achieved by means of a gate or window comprising one or two doors with movable elements which elements pivot around one or more axes perpendicular to the plane formed by the closed gate itself. During the closing movement, the elements move with a synchronism that allows them to be packed on one another and to lie in a radial pattern while opening according to a so called fan out mode.

The invention solves the problems raising at installation of conventional gates and windows. Thanks to the hand-fan structure the door is able to open by occupying an increasingly small room up to be contained in the column of the gate or in the wall around the door/window.

A fan-type gate according to the invention solves the problem of space as the door disappears in the column suitably constructed with a hollow structure capable of containing also the eventual drive mechanism. A fan-type door/window according to the invention can be adopted as an alternative of a folding one and, unlike this, does not need any sliding guide.

Furthermore, a gate with fan out door according to the invention is not affected by the slope of the ground where it needs to be installed, both with longitudinal, transverse or in any other way sloping of the access. Even in the case of a gate with two doors the problem is solved by placing the columns on two different planes and synchronizing the fan angle so that they close parallel to the ground.

In addition, a gate with doors having a hand-fan structure according to the invention does not need stroke end housings on the access road.

Finally, in a fan-type gate according to a preferable embodiment of the invention the door and the support column are part of a single structure in which are enclosed the mechanisms for the manual or automatic drive. The hollow structure of the columns can be subsequently embedded in the wall and coated with plaster but this phase will have no effect on the operation of the gate.

### DESCRIPTION OF DRAWINGS

Further characteristics of this invention will be better understood with the following description which make reference to the attached drawings, given as practical examples of the invention but not to be considered in a limiting sense, in which;

FIG. 1 represents a first embodiment of a gate according to the present invention in the closed configuration;

FIG. 2 is the gate of FIG. 1 in the open configuration;

FIG. 3 is a perspective view of a different embodiment of a door of the gate of FIG. 1 in the open configuration;

FIG. 4 is the door of FIG. 3 in the closed configuration;

FIGS. 5 to 7 show in greater detail certain components of the gate of FIG. 1 according to a second embodiment of the movement synchronization means;

FIG. 8 shows a perspective view of a further embodiment of the gate of FIGS. 5-7;

FIGS. 9 and 10 show a front view of two further embodiments of the gate of the invention relating, in particular, to the shape of the gate;

FIG. 11 shows a front view of a door of a window or internal door according to the present invention;

FIG. 12 shows an embodiment of a door of a gate according to the invention similar to that of FIG. 9;

FIG. 13 shows in perspective view a portion of the door of FIG. 12;

The FIG. 14 shows in perspective view a detail of a door of the gate according to the invention which represents the movement synchronization means;

FIG. 15 shows in perspective view a detail which shows a different embodiment of the organs of synchronization of the movement;

FIGS. 16 to 18 show, respectively in the open, intermediate and closed configuration, a door of a further embodiment of a gate according to the invention.

### DETAILED DESCRIPTION OF PREFERRED EMBODIMENTS

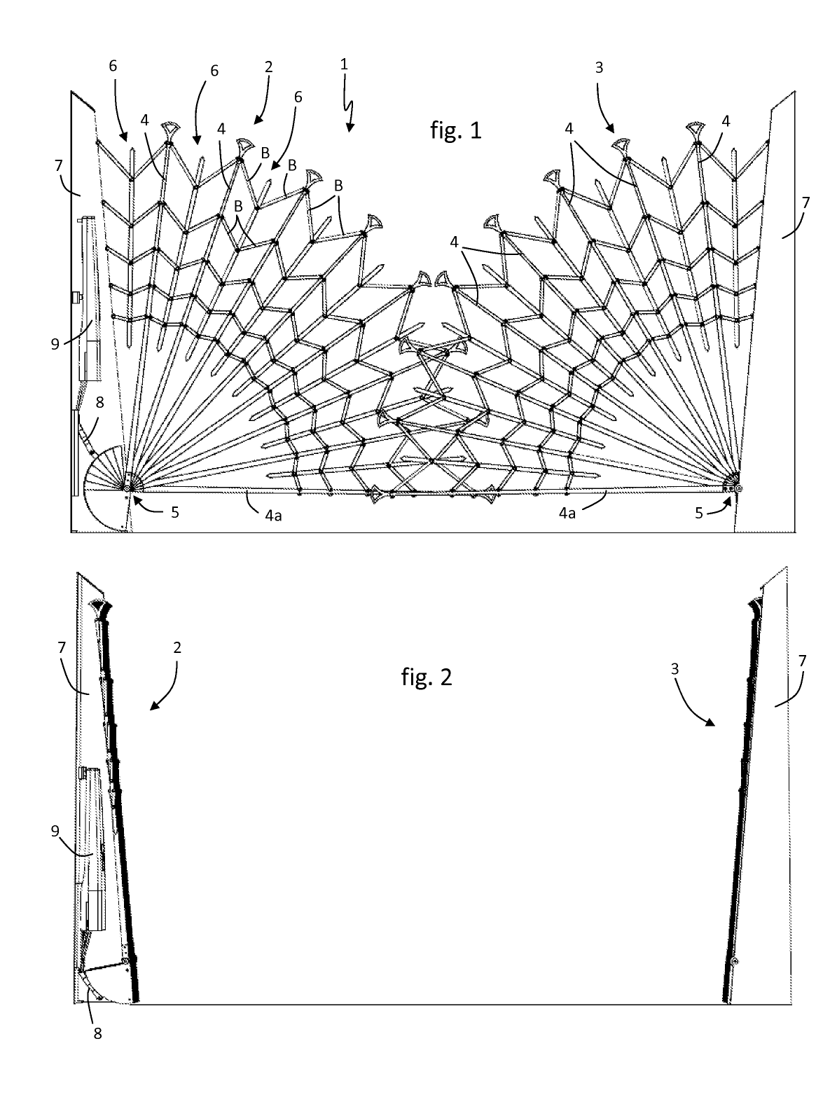

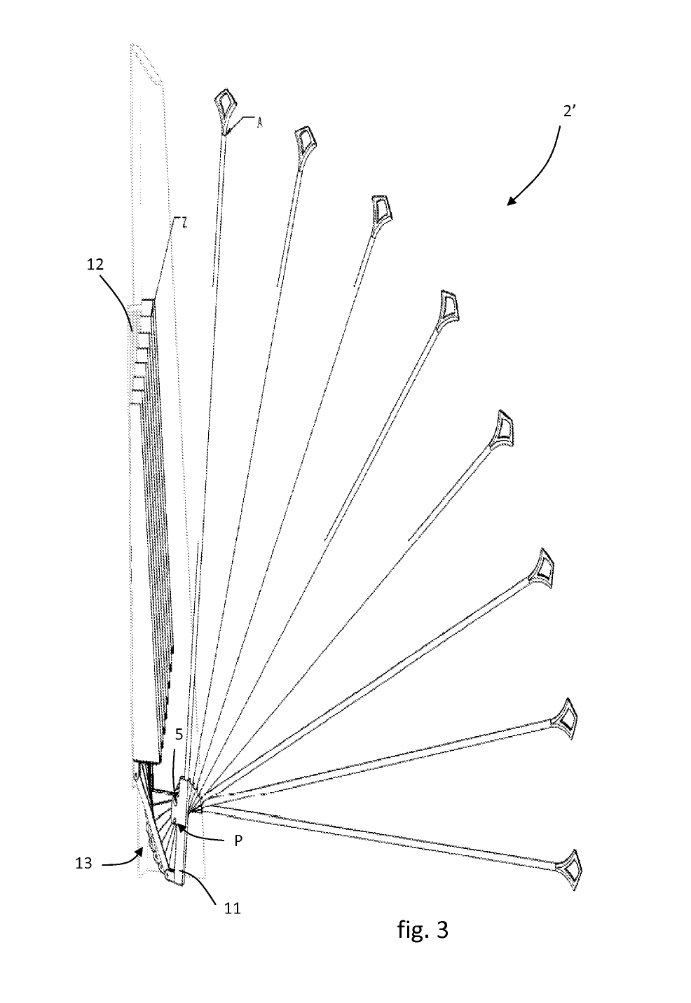

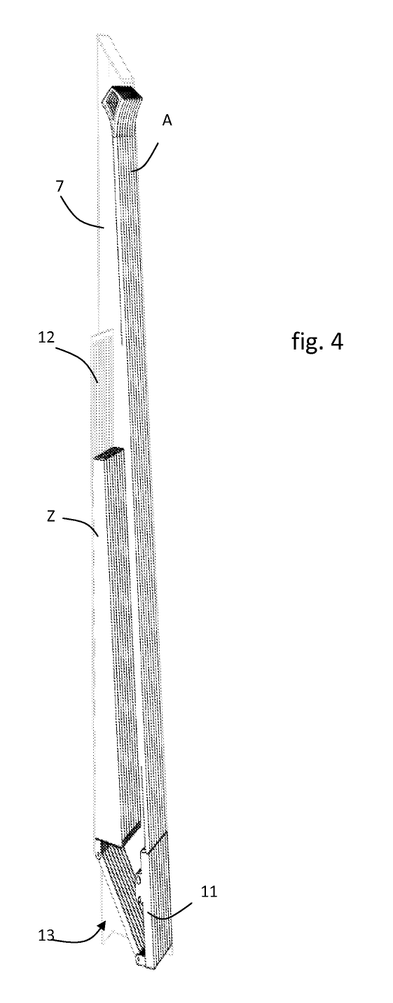

With reference to Table 1 (FIG. 1 and 2) is represented a gate, 1, with two fan-type doors, 2, 3, according to the present invention. In FIG. 1 is shown the gate in the closed configuration and in FIG. 2 is shown the gate in the open configuration. Each door 2, 3, has eight rods, 4, rotating around an axis, 5, perpendicular to the plane of closure. The movement of the rods is synchronized by interposed elements, 6, articulated between them. The balancing and driving mechanism is housed in a column, 7, having a hollow structure with a ‘U’ cross section when viewed in plan. In the closing phase (FIG. 1) a connecting rod, 8, controlled by an actuator, 9, exerts a tensile force on a control rod 4a which carries with it the other rods 4, thanks to the connection by means of the respective interposed elements 6. The arms, R, of the interposed elements 6 opens with a scissor movement and the closing movement ends when the arms B of the interposed elements 6 reach their maximum extension permitted. At that stage the control rod, 4a, has reached the position closest to the ground. In the opening phase the control rod 4a exerts a compressive force on the interposed elements 6 and the arms B of these close gradually as scissors up to intercept the rods 4 with predetermined end stroke. At complete opening the rods 4 and interposed elements 6 are bundled up to form a single profile that can be contained in the cavity of the column 7. The drive mechanism is constituted by a linear actuator 9 which through appropriate motion transmission means, consisting in this example in the connecting rod 8 and more rods hinged to it, causes rotation of the control rod 4a.

In table 2 and table 3 it is shown a different embodiment of a gate or window according to the invention in which there is only one door, 2′, whose fan structure is composed only by rods A. Table 2 shows the gate in the closed configuration, table 3 shows the gate in open configuration.

The synchronism of the rods A, is ensured by the pins P and the slots formed in the levers, 11, or counterweights that support the rods A. In this embodiment, the door opening is hand-driven, and to facilitate the fan out opening of the door, 2′, were inserted ballast Z, one for each rod A, vertically slidable on guides, 12, integral to the column 7 and connected to the rods A through a system of connecting rod and crank, 13. This type of construction can be defined kinetic-balanced fan out door. Additional embodiments may provide for the application to the levers 11 of the rods A of one or more springs, thus obtaining a dynamic balancing, balancing that can replace or assist the effect of the ballast Z.

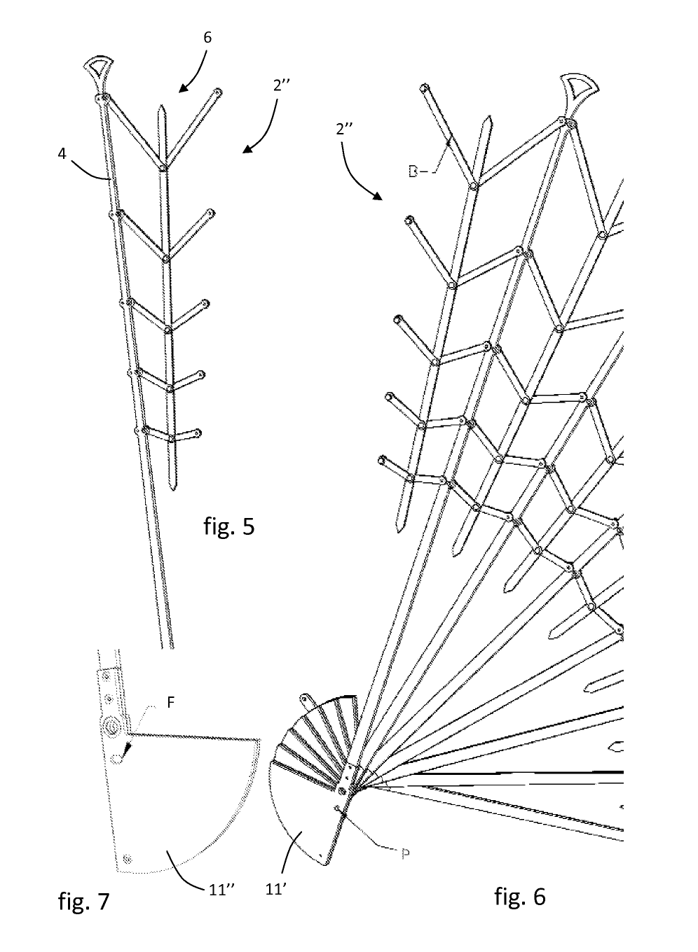

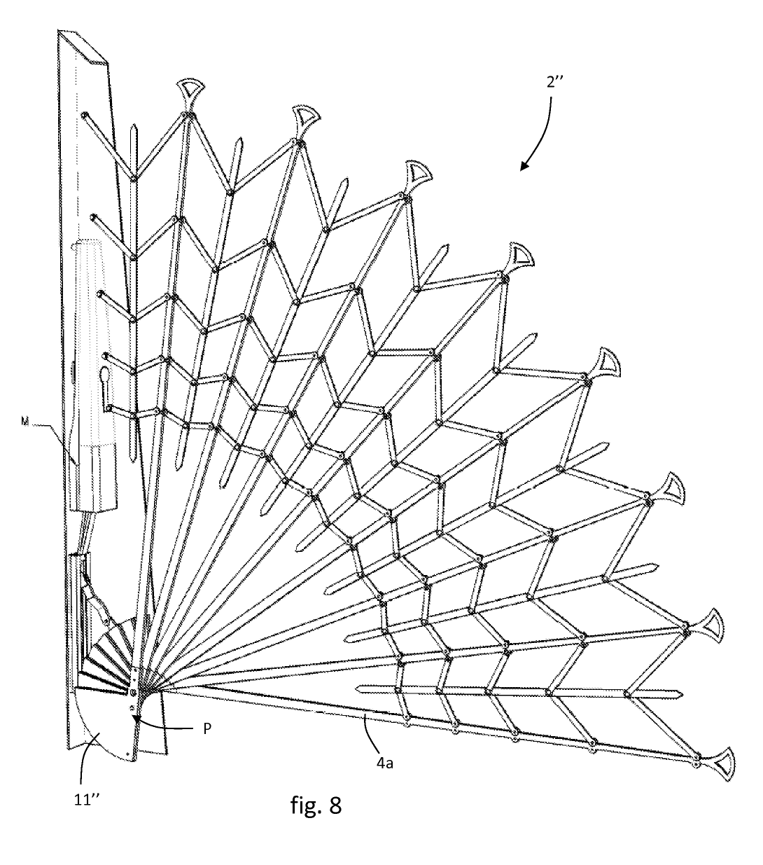

In table 4 are shown some details of the structure of a gate according to a further embodiment of the present invention. FIG. 5 shows a rod 4 with a respective interposed element 6, the structure of which corresponds to that of the gate of FIG. 1. FIG. 6 shows a portion of a door 2″ with some of the rods 4 and the respective interposed elements 6 and the support elements 11″ shaped in circular sector so as to increase the weight and thus act as counterweights which tend to balance the weight of the relative rod 4. FIG. 7 shows a detail of a support element 11″ of a rod. In this case, fan out opening is ensured as in table 1 by the connectors 6, B, while the synchronous movement of the rods 4 is ensured by pins P and loops, F, obtained in the circular plates, 11″, that support the rods 4, as is the case of the example of tables 2 and 3. To the synchronism of the opening contribute the movable arms B inserted between the rods 4 which widen and close on themselves to form a single package with the rods 4 at the end of door 2″ opening. To lighten the task of the drive mechanism a ballast has been applied, constituted by a plate with circular shape of the support element 11″, at the foot of each rod 4 and integral with the rod itself.

In Tab. 5 is represented an overall perspective view of the gate with one fan-type door in accordance with the table 4. The actuator M of the drive mechanism transmits the movement to the control rod 4a (the one that performs the greatest stroke) and this transmits the movement to all the other rods through a synchronization system constituted by slot F and pin P obtained in the foot 11″ of the rods 4, while the interposed elements 6 are articulated so as to open and close with the rotation of the rods 4.

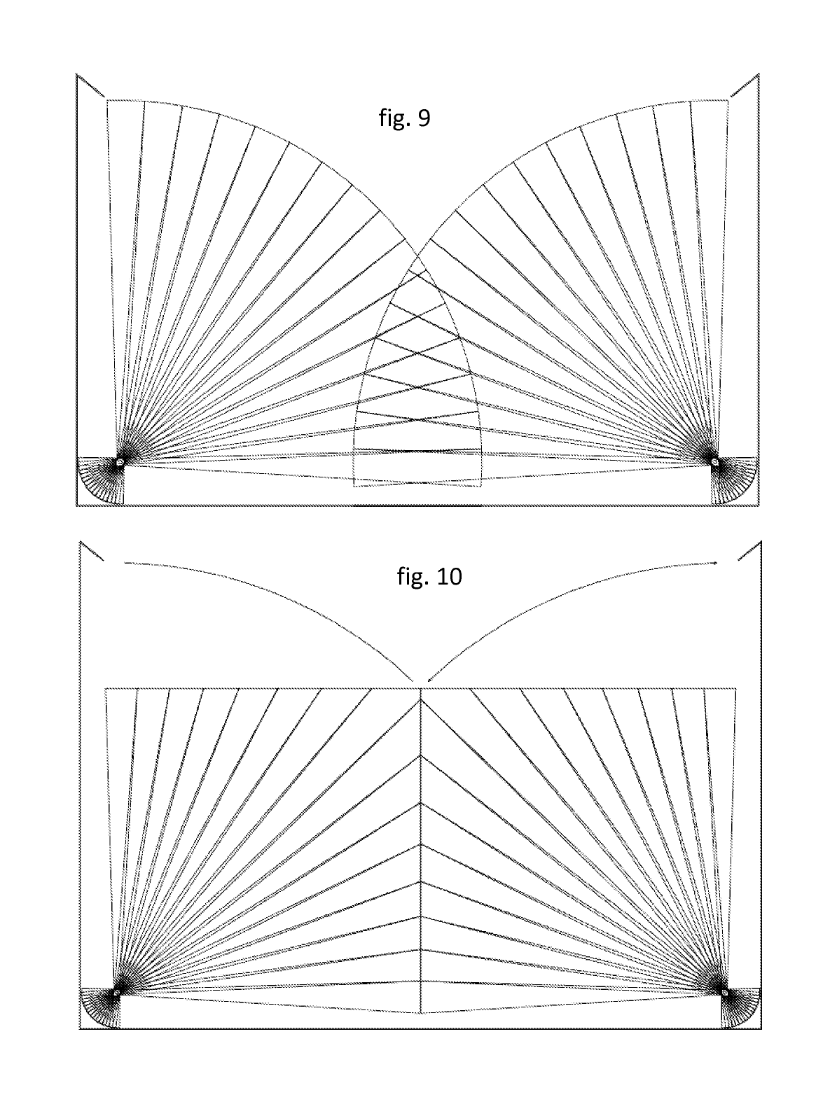

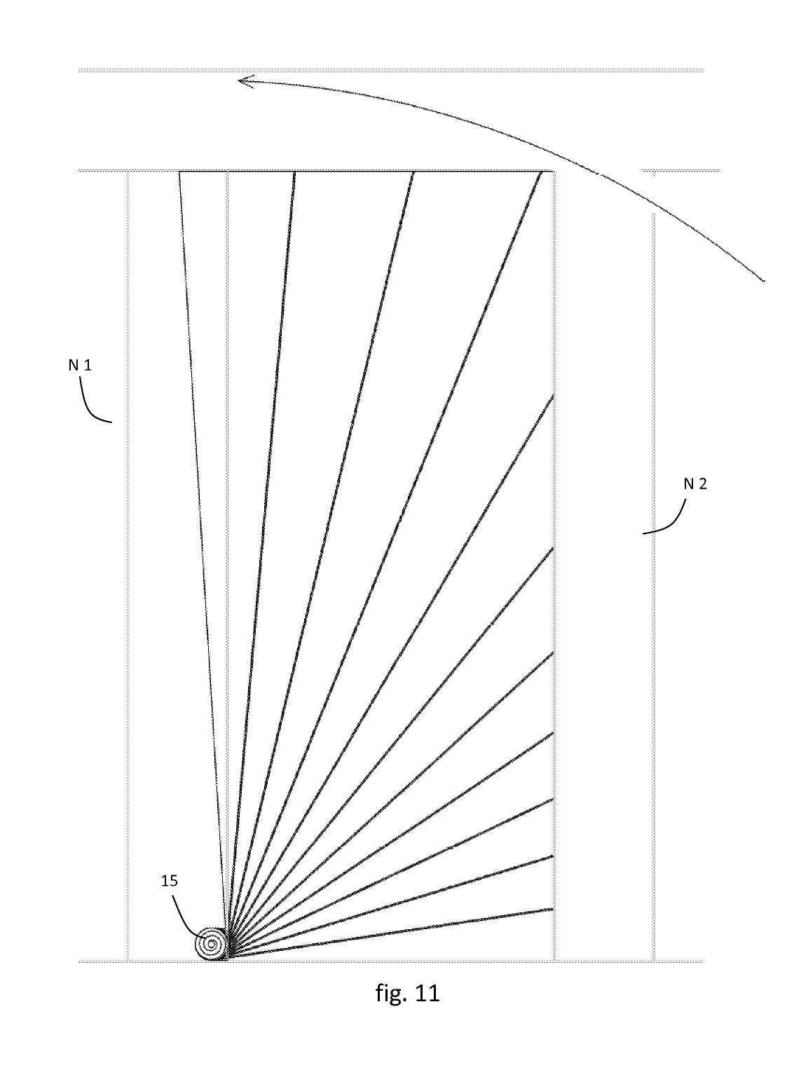

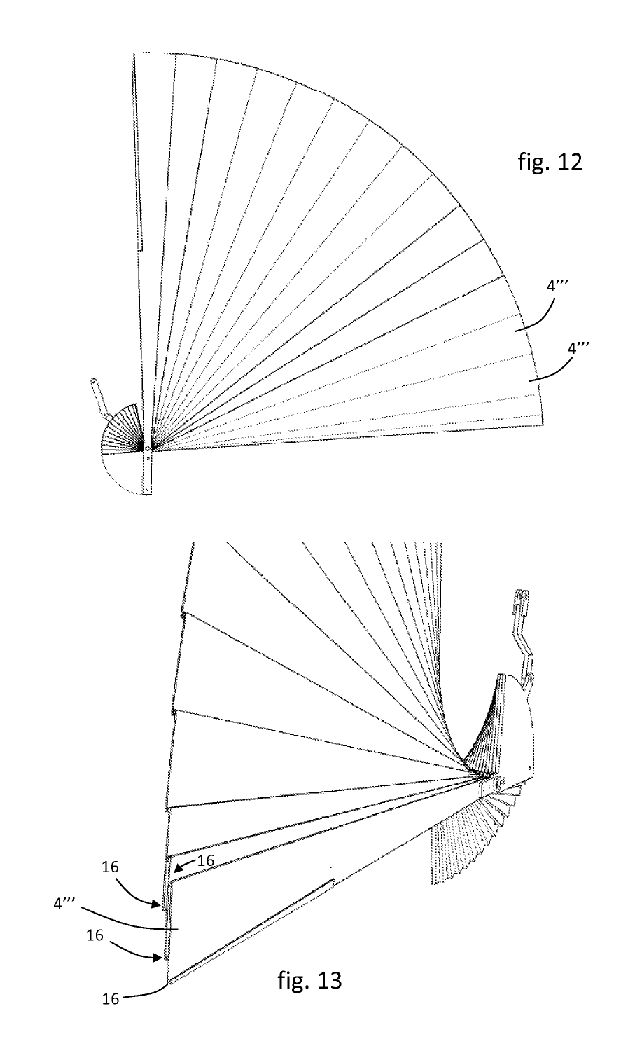

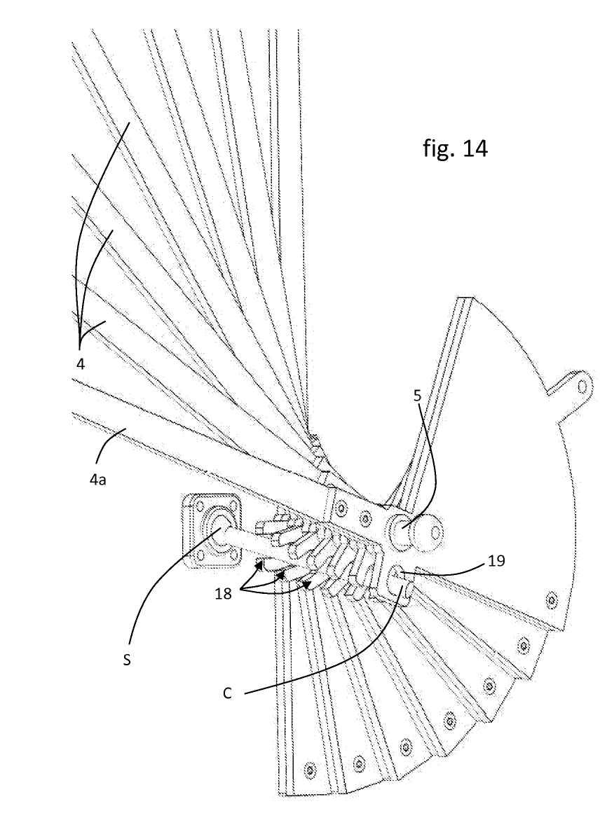

In Tab. 6 are-represented schematically a gate with fan-type doors composed of rigid elements with circular external side (FIG. 9) and angular (FIG. 10), respectively. To this type of doors are then applied systems of synchronism and balancing described above. During the closing movement the rigid elements are packaged one above the other as the rods of the previous systems.

In Tab. 7 is shown schematically an internal door to close the access between two walls, N1, N2. The door is composed of rigid elements connected each other by one or more interposed flexible elements made of material such as canvas, fabric or synthetic material having characteristics of flexibility. A spiral spring, 15, inserted into the drum for rotation of the tan-type door makes it easy the hand-driven opening and closing. When the door opens the rigid elements are packed disappearing into the wall.

In Tab. 8 is represented the structure of a fan-type door, 2″′ of a circular shape. The door 2′″ is constituted by rigid elements, 4′″, in the shape of a circular sector which in the position of maximum opening of the fan-type door engage onto each other through a special lip 16, which determines a stroke end position in the closed configuration as it prevents two consecutive rods from further rotating with respect to each other. Since, by virtue of their circular sector shape, even in the closed configuration of the door two subsequent rigid elements 4″′ remain partially overlapped, the door has in this embodiment closed structure with greater rigidity, resistance to tampering and blinding efficiency. Obviously, the connection with interlocking lips 16 between two subsequent elements 4 can also be realized without using elements of size and shape such as to constitute a continuous surface in the door closed configuration.

In Tab. 9 is represented schematically the detail of an embodiment relating in particular to the synchronization system of the elements which open with a fan out movement. In this example the rods 4 move in a synchronized way thanks to the interaction of a synchronization shaft, C, with front forks, 18, integral with the rods 4 themselves. The synchronization shaft C is bound at one end to a fixed point of the column housing 7 via a ball joint S, while the other end, is connected via a slot, 19, to the control rod 4a. While it change its inclination, the synchronization shaft C maintains its contact with the forks 18 which are integral with the other rods 4 so forcing them to open and to close with equal angles between them and a movement constantly synchronized. The system of synchronization of this embodiment allows an opening guided such that all the rods 4 are spaced by the same angle in both the extreme configurations of opening and closing of the gate and in each intermediate configuration that this assumes. Even in this embodiment, to ensure the correct end of stroke angle between the rods in the configurations of opening and closing of the door may be present the system with pin P and slot F described in tables 4 and 5.

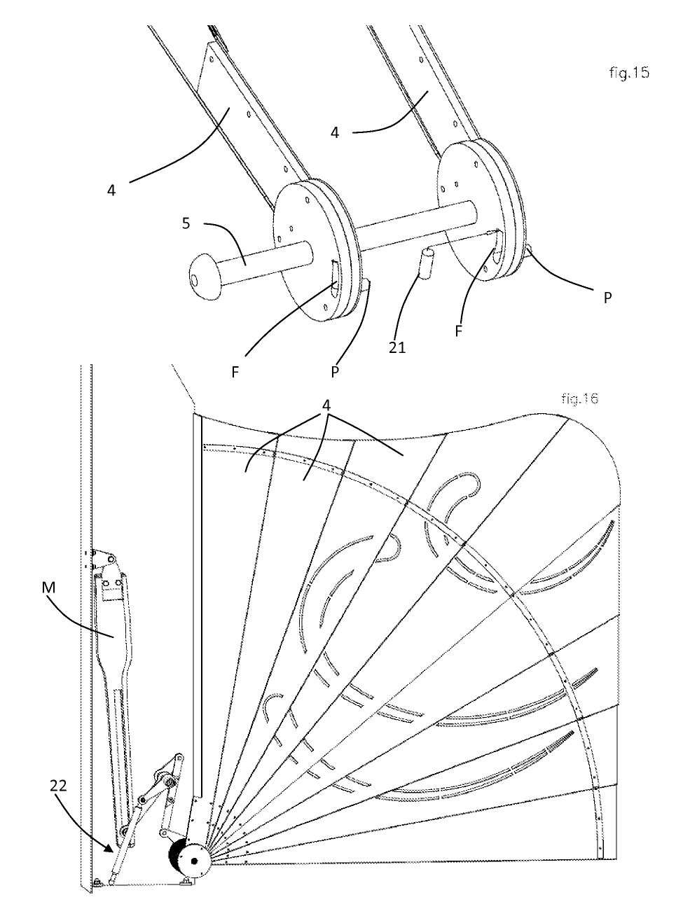

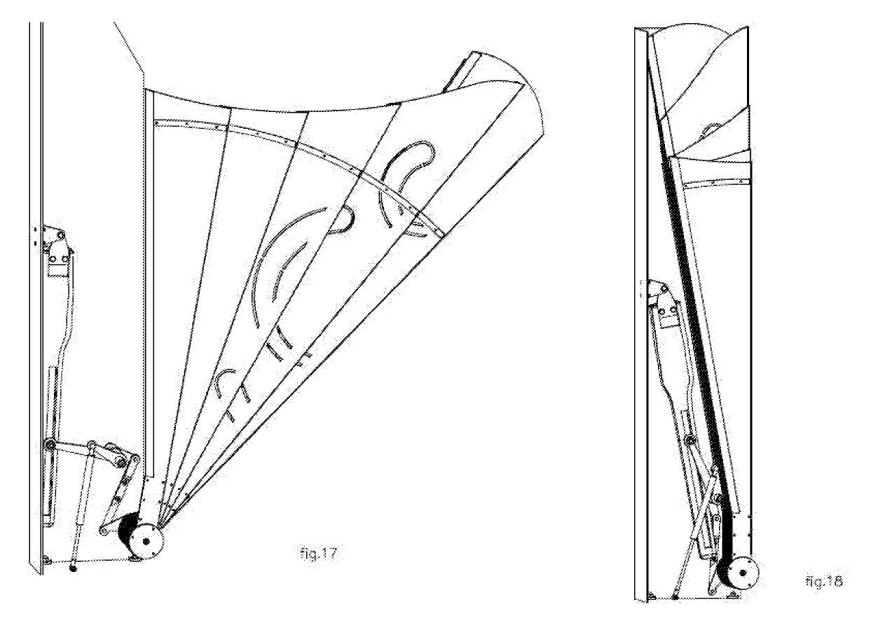

In Tab. 10 and 11 it is shown a further embodiment, covering both the system of synchronization of the fan out opening elements, both the drive mechanism. As shown in the detail of FIG. 15, each rod 4 comprises a pin P which is inserted in the slot F of the following rod, exactly as is the case of the embodiment, shown in tables 4 and 5. In the slot F is inserted a coil compression spring, 21, which acts between the wall of the slot F itself and the pin P so as to generate a force that tends to rotate the two mobile elements 4 in the gate closing direction. Indeed, since the gate door is constituted by solid rigid elements each of which has a certain weight the movement of opening and closing appears to be mainly due to the own weight of each element and they move reciprocally in succession and starting from the control 4a . In this case, the presence of springs 21 housed in each of the slots F at least partially balance the weight of the elements 4 and helps to maintain accurate and coordinated movement in succession. Obviously, the compression coil springs 21 could be replaced with other elastic elements, which elements polyurethane, torsion springs or other, mounted so as to perform the same function of pushing two elements 4 subsequent to close overlapping.

In FIGS. 16 , 17 and 18 can be easily understood the operation of the drive mechanism that includes a linear actuator, M, kinematic hinged rods, and a gas spring, 22. The kinematism with hinged rods allows the use an actuator of M of low power and stroke and at the same time to contain the overall size of the column 7 in which is housed the drive mechanism. Furthermore, the gas spring 22, hinged at one end to the column 7 and the other end to a suitable point of the hinged rod kinematism, partially balance the weight of the rigid elements 4 and helps to damp the opening and closing movement.

1.-14. (canceled)

15. A gate or window/door frame comprising:
one or two doors with mutually moving elements, wherein the moving elements are hinged together for rotating around one or more axes perpendicular to a plane of the door itself such that, during a door closing movement, the moving elements synchronously move in a manner that permits them to close at a packed on one another configuration and, during an opening movement, the moving elements spread in a radial pattern in a manner that corresponds to an opening of a hand fan.

16. The gate or window/door frame according to claim 15, wherein during the door closing movement, the moving elements open out to a predetermined mutual distance defined by a stop system integrated in the moving elements themselves and comprising pins and slots formed in levers that support rods, while in the door opening movement, each moving element closes in a scissor like movement on the other moving element immediately adjacent to it.

17. The gate or window/door frame according to claim 16, further comprising elastic elements mounted between the moving elements, so as to perform a pushing function to close two adjacent moving elements.

18. The gate or window/door frame according to claim 17, wherein the elastic elements are coil compression springs mounted in the slots to act between the slots and pins.

19. The gate or window/door frame according to claim 15, wherein the moving elements close and widen gradually in response to a synchronization system comprising a control rod that interacts with forks integral with the moving elements, wherein the control rod is constrained by a spherical joint and driven by a slot formed on a leading moving element, the control rod being arranged to lean by maintaining contact with the forks that are integral with the other moving elements, operable to drive the latter to open and to close with the same mutual angles and with a constantly synchronized movement.

20. The gate or window/door frame according to any claim 15, wherein the moving elements are connected to each other through articulated arms that widen at the opening of a hand fan door to reach their maximum permitted opening, wherein the articulated arms close in succession on each other upon closing of the door until an end stop integral with a lower loving element intercepts an adjacent upper moving element.

21. The gate or window/door frame according to claim 15, wherein the moving elements are connected to each other through one or more interposed elements type material selected from cloth, fabric or flexible synthetic material.

22. The gate or window/door frame according to claim 15, wherein the moving elements are comprised of rigid elements in the shape of a circular sector and having an interlocking lip so as to comprise a rigid linkage during closure of the door.

23. The gate or window/door frame according to claim 15, wherein the moving elements are balanced by a ballast, one for each moving element, the ballast being vertically slidable on guides that are integral with a housing column having a hollow structure and being connected to the moving elements via a rod and crank connecting system.

24. The gate or window/door frame according to claim 15, wherein the moving elements are balanced by weights constituted by a support element secured to a foot of each moving element and integral with the movement of the moving elements.

25. The gate or window/door frame according to claim 15, wherein the moving elements are balanced by one or more resilient members applied to the levers of the moving elements.

26. The gate or window/door frame according to claim 15, wherein the moving elements are driven by a driving mechanism housed in the column connected to a control rod of the moving elements.

27. The gate or window/door frame according to claim 26, wherein the driving mechanism comprises a linear actuator and a transmission mechanism for transmitting motion to the control rod, the driving mechanism being formed by rods hinged therebetween.

28. The gate or window/door frame according to claim 27, wherein the driving mechanism comprises at least one gas spring adapted to partially balance the weight of the moving elements.
